(19) United States
(12) Patent Application Publication
(10) Pub. No.: US 2026/0135288 A1
(43) Pub. Date: May 14, 2026

(54) ADJUSTABLE STRUCTURE FOR ANTENNA MOUNTING BRACKET

(71) Applicant: Xue-Feng Chen, Guangzhou City (CN)

(72) Inventor: Xue-Feng Chen, Guangzhou City (CN)

(21) Appl. No.: 18/983,396

(22) Filed: Dec. 17, 2024

Related U.S. Application Data
(63) Continuation-in-part of application No. 18/946,891, filed on Nov. 13, 2024.

(51) Int. Cl. H01Q 1/12; F16M 11/10

(52) U.S. Cl. CPC H01Q 1/1264; F16M 11/10; F16M 2200/024; F16M 2200/066

(57) ABSTRACT

The present invention relates to an adjustable structure for an antenna mounting bracket, which includes: a first arm with first positioning holes; a second arm, with an arm-facing end as one end and a wall-facing end as the other end, the arm-facing end having second positioning holes, and the first and second arms being configured as square tubes; a plurality of first fixing pins, respectively inserted into the corresponding first and second positioning holes; and a wall-mounting component, connected to the wall-facing end. The wall-facing end is provided with a third positioning hole and a first pivot hole. The wall-mounting component is provided with fourth positioning holes in an arc arrangement and a second pivot hole. A pivot shaft is inserted through the first and second pivot holes, while a second fixing pin is inserted through the third positioning hole and a corresponding one of the fourth positioning holes.

### CROSS REFERENCE TO RELATED APPLICATIONS

This application is a continuation-in-part of U.S. application Ser. No. 18/946,891 filed Nov. 13, 2024. The entirety of said Application is incorporated herein by reference.

### BACKGROUND OF THE INVENTION

### Fields of the invention

The present invention relates to an adjustable structure for an antenna mounting bracket, used to assist in the installation of an antenna dish in a router system.

### Descriptions of Related Art

Routers are widely used in households to provide network signals, and some models have the function of enhancing signals. To provide internet access, routers need to be paired with other equipment to form a complete system. Taking the Starlink router as an example, it includes an antenna dish, a main unit, and a power supply. The main unit connects the antenna dish to the power supply. The advantage is that, regardless of the user's location, as long as the antenna dish is not obstructed, the user can obtain stable internet speeds at any time.

When setting up a Starlink router, the antenna dish is usually installed outdoors (such as on the roof of a house) and should remain unobstructed. The main unit and power supply can be installed indoors. A common method for installing the antenna dish is to use a bracket to fix it to the roof. However, the existing brackets on the market only provide support and have some shortcomings. In fact, there is an optimal reception angle for an antenna dish, but not every installation location has the same conditions, such as differences in roof shape or slope. As a result, when the bracket is used to install the antenna dish in a target location, the reception angle of the antenna dish is often less than ideal, leading to reduced system performance.

In view of the above-mentioned issues, it is evident that the current brackets for antenna dishes on the market have the problem of poor reception angles during installation.

### SUMMARY OF THE INVENTION

The present invention aims to address conventional problems by providing a structure that includes a first arm and a second arm. The first arm and the second arm are provided with first positioning holes and second positioning holes, respectively. During use, the first arm can be pivoted relative to the second arm, and first fixing pins can be inserted to the corresponding first and second positioning holes to secure them. Accordingly, the angle between the first arm and the second arm can be changed. Additionally, the second arm and the wall-mounting component are respectively provided with a third positioning hole and fourth positioning holes. During use, the second arm can be pivoted relative to the wall-mounting component, and a second fixing pin can be inserted to the corresponding third and fourth positioning holes to secure them. This allows the angle between the second arm and the wall-mounting component to be adjusted. As such, a wall-mounting component connected to the second arm can be installed on a wall or roof, while the first arm is connected to an antenna dish mounting seat, providing various angle settings. This improves the issue of poor reception angles when mounting antenna dishes with current brackets on the market. The present invention demonstrates novelty and inventive step.

To achieve the above effects and objectives, the present invention provides an adjustable structure for an antenna mounting bracket, which includes: a first arm, with a plurality of first positioning holes at one end thereof; a second arm, with an arm-facing end as one end and a wall-facing end as the other end, the arm-facing end having a plurality of second positioning holes, and the first arm and the second arm being configured as square tubes; a plurality of first fixing pins, respectively inserted into the plurality of first positioning holes and the plurality of second positioning holes corresponding to each other; and a wall-mounting component, connected to the wall-facing end of the second arm. The wall-facing end of the second arm is provided with a third positioning hole and a first pivot hole. The wall-mounting component is provided with a plurality of fourth positioning holes in an arc arrangement and a second pivot hole. A pivot shaft is inserted through the first pivot hole and the second pivot hole, while a second fixing pin is inserted through the third positioning hole and one of the plurality of fourth positioning holes that corresponds to the third positioning hole.

Further, at least three of the plurality of first positioning holes correspond to at least three of the plurality of second positioning holes.

Further, the fourth positioning holes are in an odd quantity.

Further, an angle between the first arm and the second arm is 90 degrees.

Further, an angle between the first arm and the second arm is 135 degrees.

Further, an angle between the first arm and the second arm is 180 degrees.

### BRIEF DESCRIPTION OF THE DRAWINGS

FIG. 1 is a perspective schematic view of the present invention.

FIG. 2 is an exploded schematic view of the present invention.

FIG. 2A is an exploded view from another angle of the present invention.

FIG. 3 is an application schematic view of the present invention.

FIG. 4 is a cross-sectional schematic view taken along line IV-IV of FIG. 1.

FIG. 5 is a cross-sectional schematic view taken along line V-V of FIG. 1.

FIG. 6 is a schematic view showing the angle between the first arm and the second arm as 90 degrees.

FIG. 7 is a schematic view showing the angle between the first arm and the second arm as 135 degrees.

FIG. 8 is a schematic view showing the angle between the first arm and the second arm as 180 degrees.

FIG. 9 is a perspective schematic view for another embodiment of the present invention.

FIG. 10 is an exploded schematic view for another embodiment of the present invention.

FIG. 11 is a cross-sectional schematic view taken along line XI-XI of FIG. 9.

### DETAILED DESCRIPTION OF THE PREFERRED EMBODIMENT

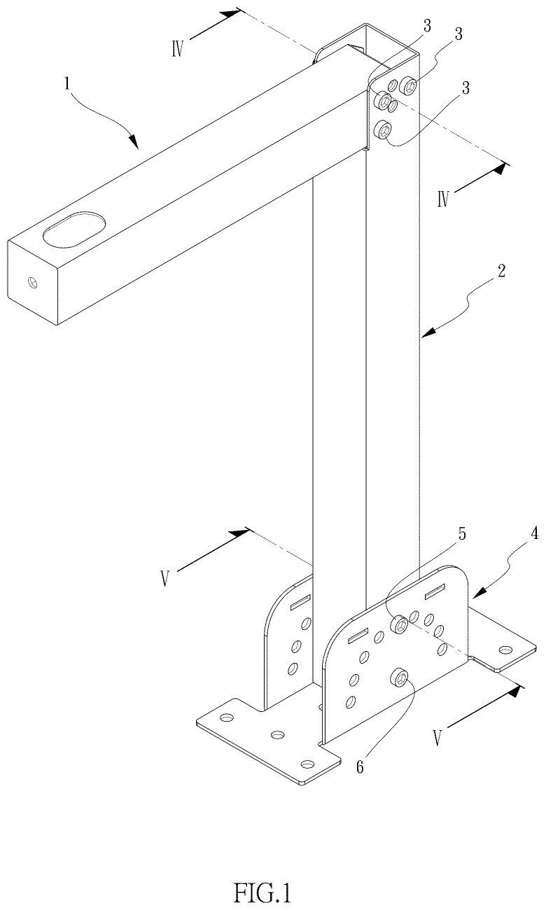

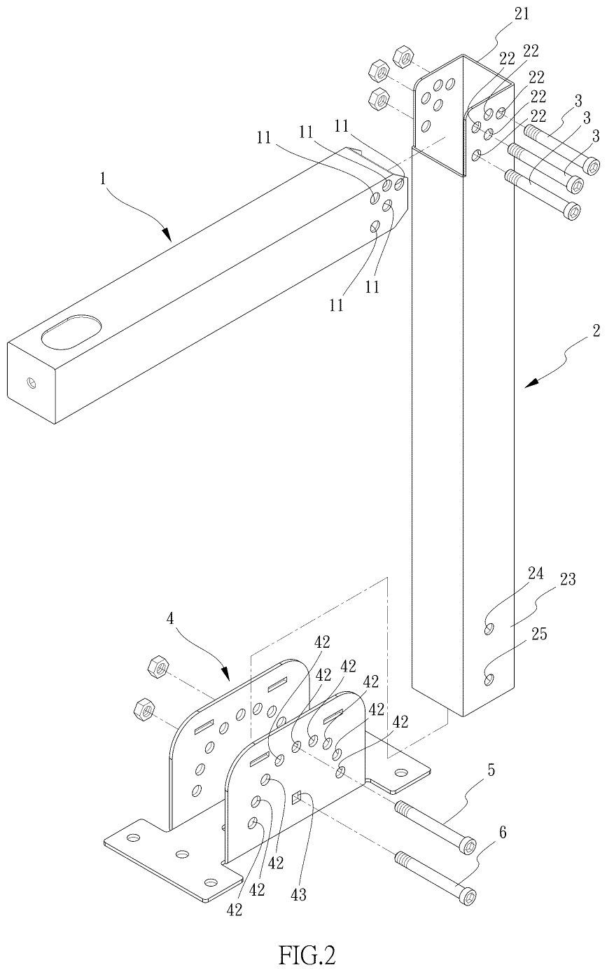

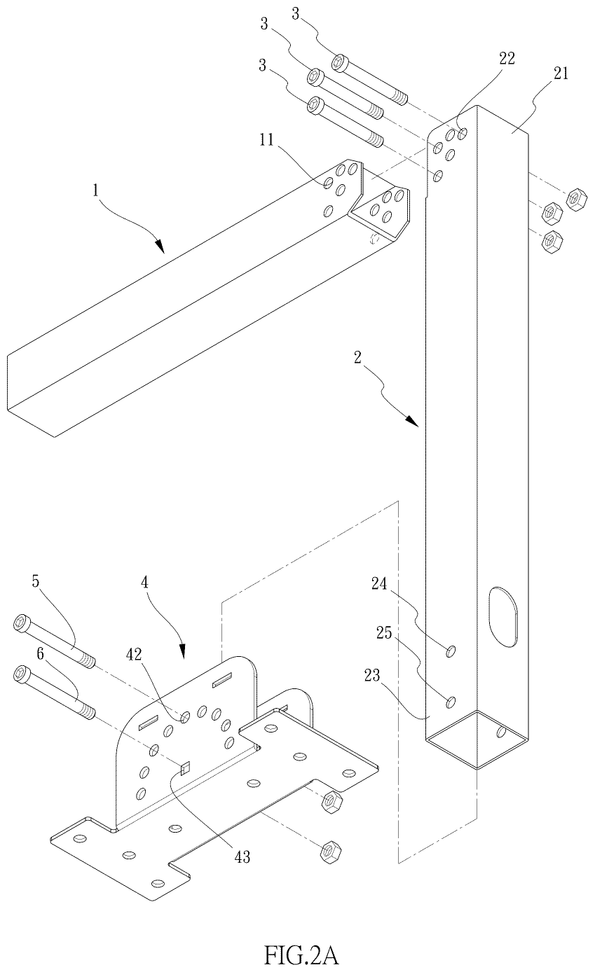

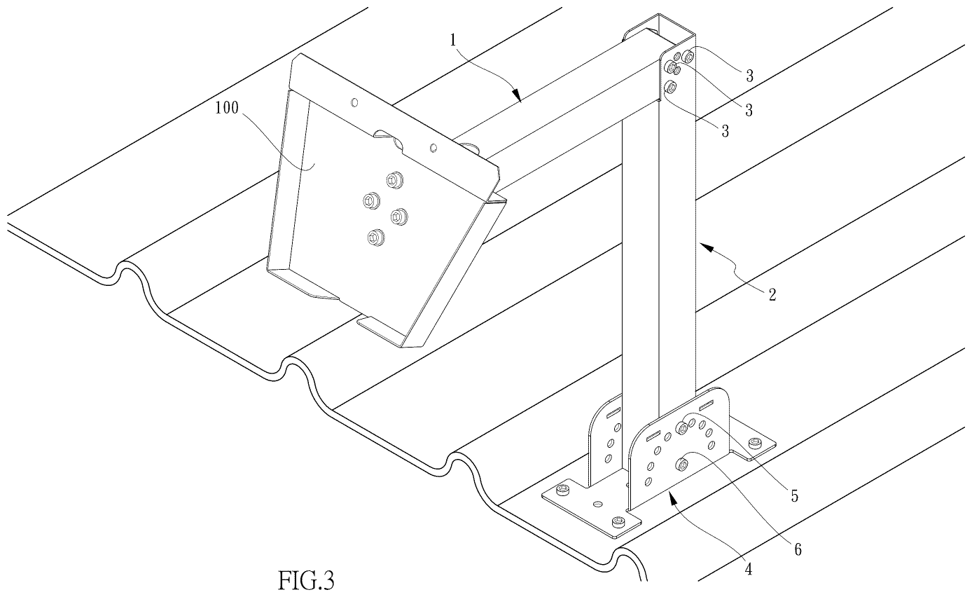

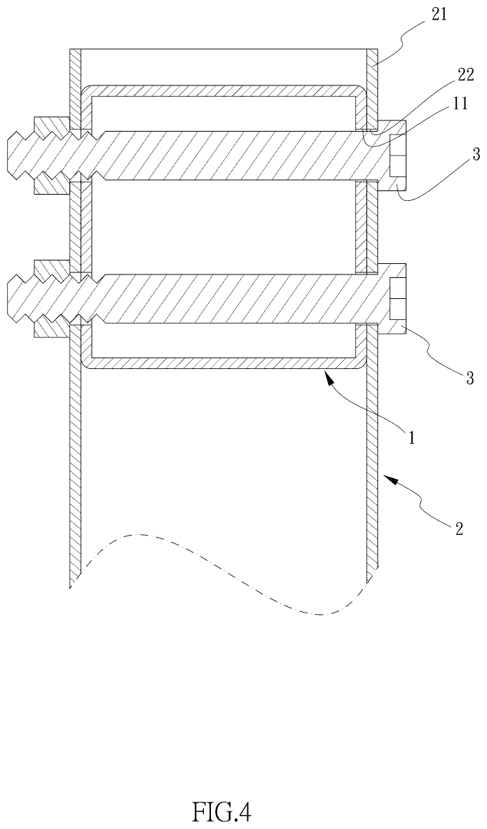

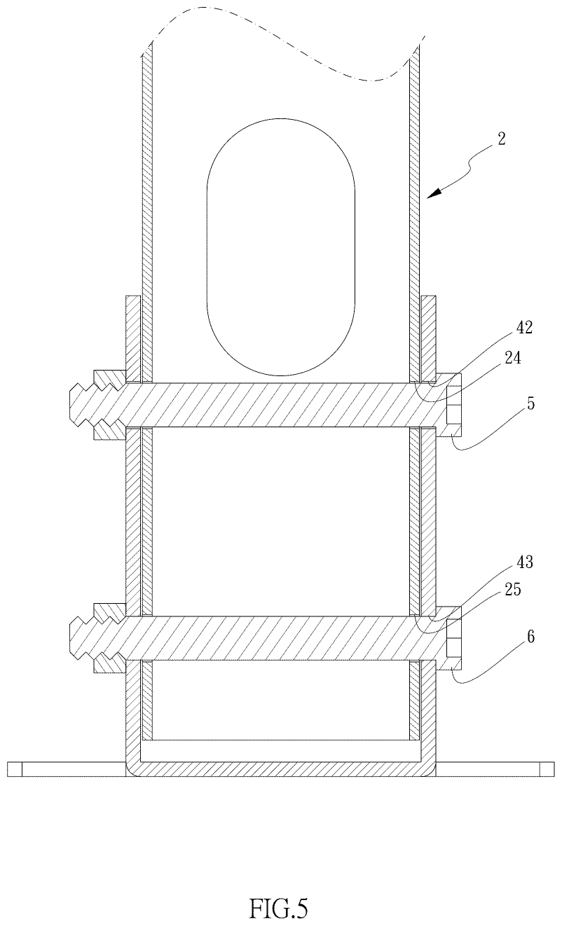

For more detailed understanding of embodiments of the present invention, please refer to the accompanying figures. As shown in FIGS. 1 to 5, an adjustable structure for an antenna mounting bracket includes: a first arm 1, with a plurality of first positioning holes 11 at one end; a second arm 2, with an arm-facing end 21 as one end and a wall-facing end 23 as the other end, the arm-facing end 21 having a plurality of second positioning holes 22, and the first arm 1 and the second arm 2 being configured as square tubes; a plurality of first fixing pins 3, respectively inserted into the plurality of first positioning holes 11 and the plurality of second positioning holes 22 corresponding to each other; and a wall-mounting component 4, connected to the wall-facing end 23 of the second arm 2. The wall-facing end 23 of the second arm 2 is provided with a third positioning hole 24 and a first pivot hole 25. The wall-mounting component 4 is provided with a plurality of fourth positioning holes 42 in an arc arrangement and a second pivot hole 43. A pivot shaft 6 is inserted through the first pivot hole 25 and the second pivot hole 43, while a second fixing pin 5 is inserted through the third positioning hole 24 and one of the plurality of fourth positioning holes 42 that corresponds to the third positioning hole 24.

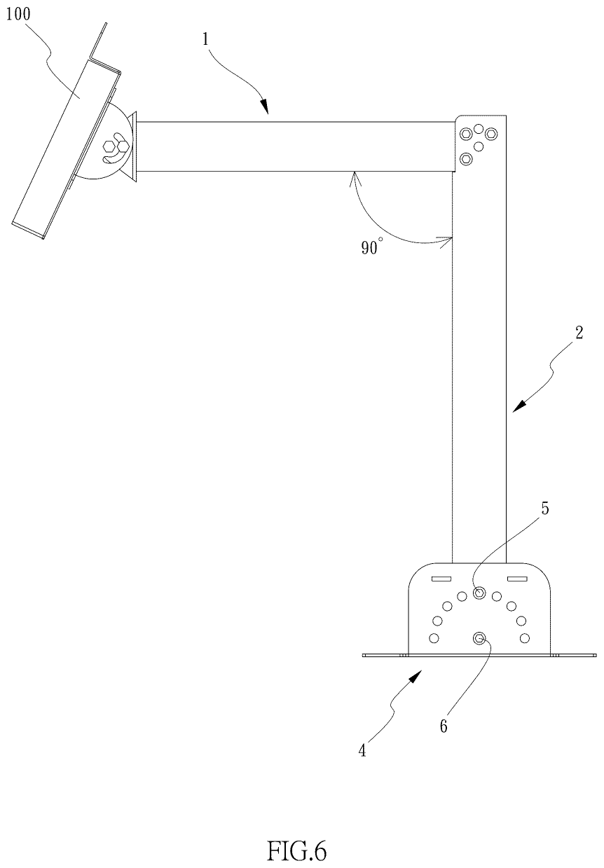

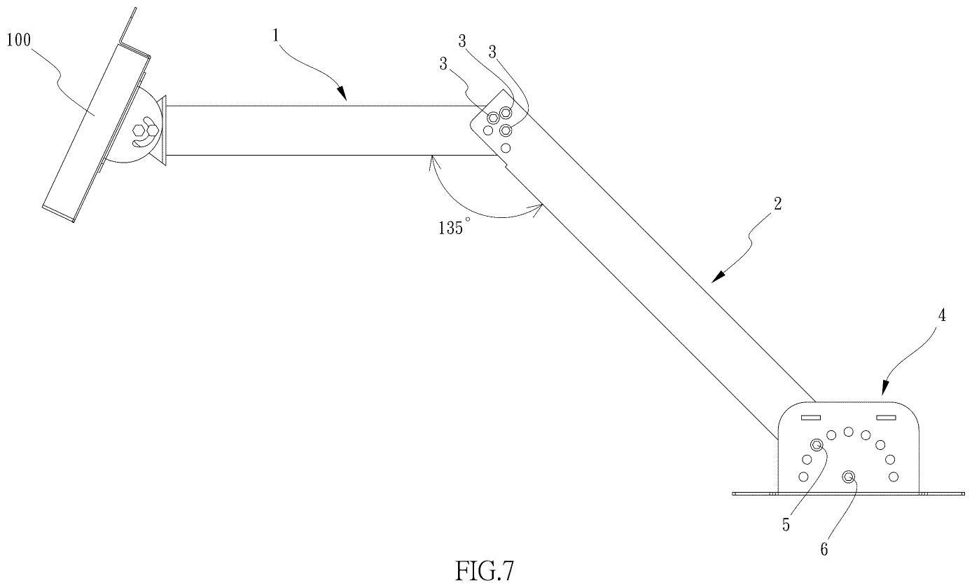

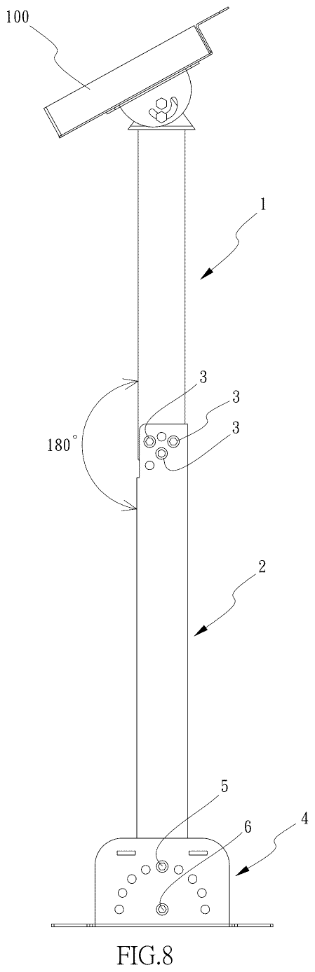

Continuing from the above, a further detailed description of the embodiment is provided. The present invention addresses conventional problems by providing a structure that includes a first arm 1 and a second arm 2. The first arm 1 and the second arm 2 are provided with first positioning holes 11 and second positioning holes 22, respectively. In this embodiment, by way of example, at least three of the plurality of first positioning holes 11 correspond to at least three of the plurality of second positioning holes 22. During use, the first arm 1 can be pivoted relative to the second arm 2 until any three pairs of the first positioning holes 11 and second positioning holes 22 correspond to each other, followed by inserting the first fixing pins 3 to secure them. Accordingly, the angle between the first arm 1 and the second arm 2 can be changed. As shown in FIGS. 6 to 8, the angle can be 90 degrees, 135 degrees or 180 degrees. Additionally, the second arm 2 and the wall-mounting component 4 are respectively provided with third and fourth positioning holes 24 and 42. During use, the second arm 2 can be pivoted relative to the wall-mounting component 4, and a second fixing pin 5 can be inserted to the corresponding third and fourth positioning holes 24 and 42 to secure them. This allows the angle between the second arm 2 and the wall-mounting component 4 to be adjusted, as shown in FIGS. 6 to 8. As such, the wall-mounting component 4 connected to the second arm 2 can be installed on a wall or roof, while the first arm 1 is connected to the antenna dish mounting seat 100, providing various angle settings. This improves the issue of poor reception angles when mounting antenna dishes with current brackets on the market. The present invention demonstrates novelty and inventive step.

The first arm 1 and the second arm 2 are configured as square tubes to allow their contact positions during assembly of the components (between the first arm 1 and the second arm 2, and between the second arm 2 and the wall-mounting component 4) to be face-to-face. This design generates greater friction between the components, thereby facilitating fine adjustments in their relative angles.

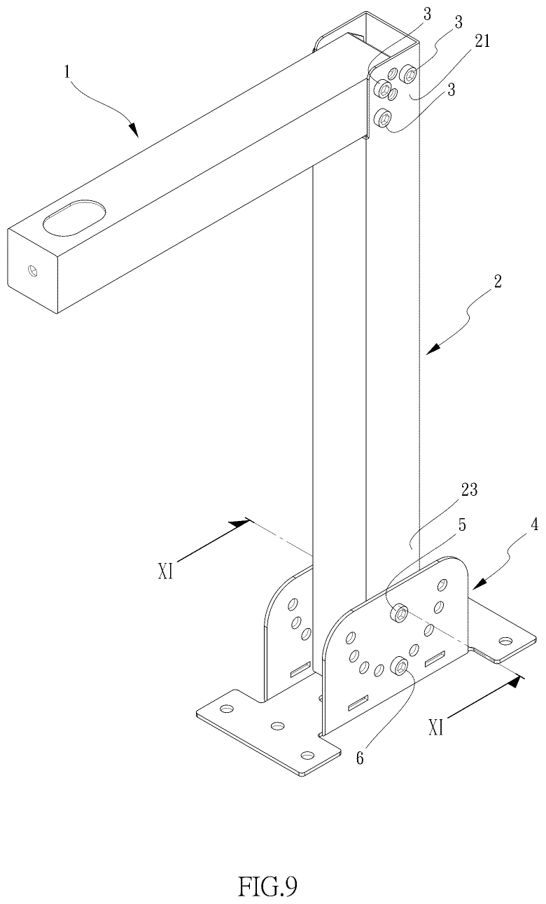

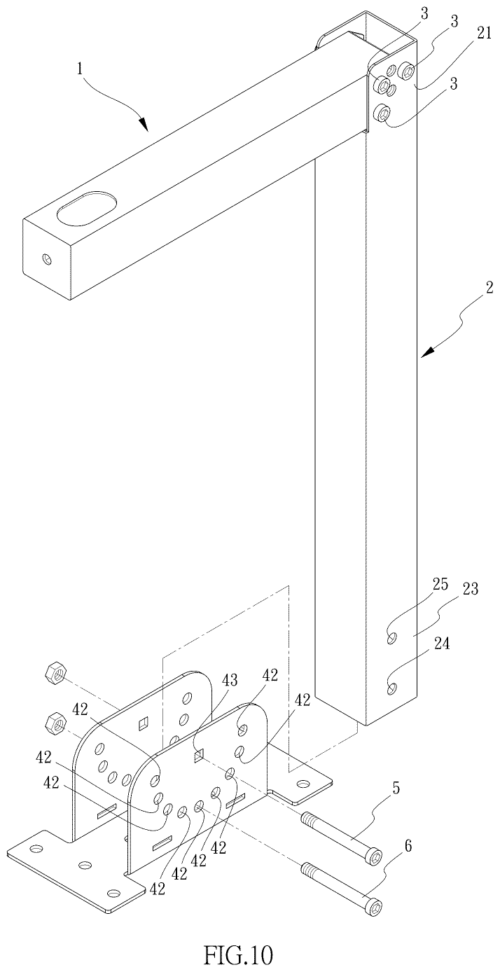

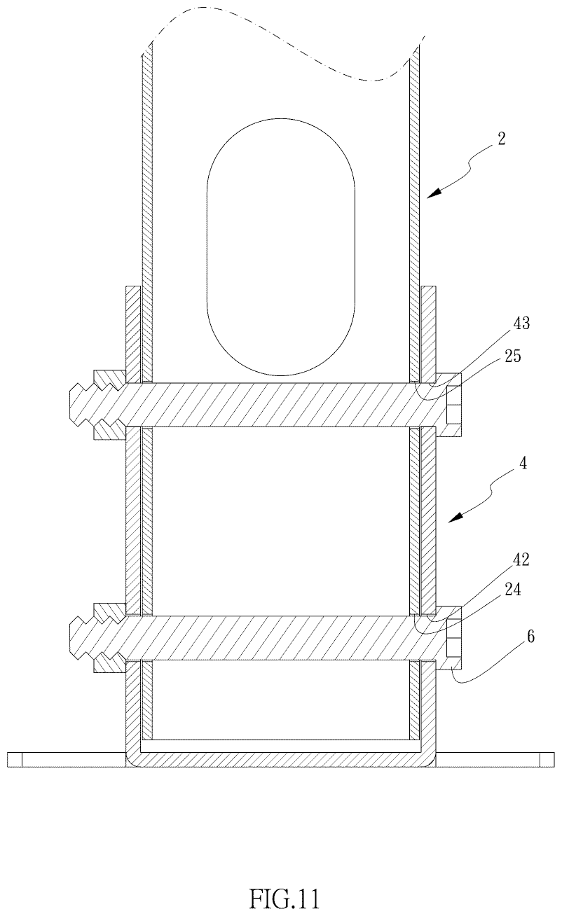

In addition to the aforementioned embodiment, the plurality of fourth positioning holes 42 can also be arranged as shown in FIGS. 9 to 11, where the arc direction of the plurality of fourth positioning holes 42 is exactly opposite to the arc direction presented in the aforementioned embodiment.

The quantity of the fourth positioning holes 42 is odd, allowing the second arm 2 to be adjusted to a perpendicular angle relative to the wall-mounting component 4.

What is claimed is:

1. An adjustable structure for an antenna mounting bracket, comprising:
a first arm, with a plurality of first positioning holes at one end thereof;
a second arm, with an arm-facing end as one end and a wall-facing end as the other end, the arm-facing end having a plurality of second positioning holes, and the first arm and the second arm being configured as square tubes;
a plurality of first fixing pins, respectively inserted into the plurality of first positioning holes and the plurality of second positioning holes corresponding to each other; and
a wall-mounting component, connected to the wall-facing end of the second arm, wherein the wall-facing end of the second arm is provided with a third positioning hole and a first pivot hole, the wall-mounting component is provided with a plurality of fourth positioning holes in an arc arrangement and a second pivot hole, a pivot shaft is inserted through the first pivot hole and the second pivot hole, and a second fixing pin is inserted through the third positioning hole and one of the plurality of fourth positioning holes that corresponds to the third positioning hole.

2. The adjustable structure for an antenna mounting bracket as claimed in claim 1, wherein at least three of the plurality of first positioning holes correspond to at least three of the plurality of second positioning holes.

3. The adjustable structure for an antenna mounting bracket as claimed in claim 1, wherein the fourth positioning holes are in an odd quantity.

4. The adjustable structure for an antenna mounting bracket as claimed in claim 1, wherein an angle between the first arm and the second arm is 90 degrees.

5. The adjustable structure for an antenna mounting bracket as claimed in claim 1, wherein an angle between the first arm and the second arm is 135 degrees.

6. The adjustable structure for an antenna mounting bracket as claimed in claim 1, wherein an angle between the first arm and the second arm is 180 degrees.
